(19) United States
(12) Patent Application Publication
(10) Pub. No.: US 2011/0001103 A1
(43) Pub. Date: Jan. 6, 2011

(54) ELEVATING MECHANISM FOR MEASURING CONCENTRATIONS OF MEDICINES

(76) Inventor: Chi-Kuang Chen, Taipei City (TW)

Correspondence Address: Muncy, Geissler, Olds & Lowe, PLLC, 4000 Legato Road, Suite 310, FAIRFAX, VA, 22033, US

(21) Appl. No.: 12/496,313

(22) Filed: Jul. 1, 2009

(51) Int. Cl. B66F 3/24

(52) U.S. Cl. 254/93 R

(57) ABSTRACT

An elevating mechanism includes a bottom seat on which is provided with a first support body and a driving motor. An interior of the first support body is defined with an elevating region which is emplaced with a second support body and a gear set to drive the second support body to elevate. A top end of the second support body is provided with a holding element which is extended downward and exposes the first support body. Through a support piece, the holding element allows medicines to enter into a concentration detection device for measurement.

### BACKGROUND OF THE INVENTION

a) Field of the Invention

The present invention relates to an elevating mechanism, and more particularly to an elevating mechanism for measuring concentrations of medicines, which effectively lowers down radiation exposure to human bodies and reduces environmental pollution to a clean room.

b) Description of the Prior Art

In an early time, a positron computer tomography technology is mostly used to detect diseases, wherein positron-emission nuclides (radiopharmaceuticals) used by the positron computer tomography technology are produced from an accelerator, and then synthesized to many various compounds which are delivered to each infirmary. When the radiopharmaceuticals are to be delivered to each infirmary for use, the radiopharmaceuticals should be dispensed, quantified and detected with concentrations that the radiopharmaceuticals can be safely transported for use. However, as most of the radiopharmaceuticals are radioactive and therefore, if one cannot deal with radiation protection well, it will result in a great and severe impact to health of implementing personnel.

In general, when measuring concentrations of medicines, the medicines are mostly retrieved manually. The process is that the medicines are first put in vials and then the concentrations of the medicines are detected through a concentration detection device. Furthermore, that process must be performed in a clean room to prevent from resulting in biases to detection values by foreign factors. On the other hand, another concentration measurement process is more advanced and can reduce a manpower cost and increase detection efficiency. This concentration measurement method uses a pneumatic elevating mechanism to emplace the vials into the concentration detection device for detecting the concentrations, allowing the implementing personnel to have fewer burdens and effectively reducing radiation damages.

The aforementioned pneumatic elevating mechanism uses a pneumatic motor as a medium to elevate the vials to enter into or exit from the concentration detection device, thereby reducing the radiation damages to the implementing personnel.

However, the pneumatic elevating mechanism is actually provided with following issues and shortcomings which need to be improved.

When the pneumatic elevating mechanism is used in the clean room, there will be a concern of gas leakage. As described above, when measuring the concentrations of the medicines, the medicines should be detected in the clean room, with primary reasons to reduce contact with ambient dirty air and decrease the biases of the detection. Nevertheless, when the pneumatic elevating mechanism is operating, a gas discharge problem is easily resulted, which will cause an issue of gas leakage during elevating the vials, thereby contaminating environment of the clean room to bias the detected concentration values.

### SUMMARY OF THE INVENTION

The primary object of the present invention is to provide an elevating mechanism for measuring concentrations of medicines, wherein the elevating mechanism includes a bottom seat on which is provided with a first support body and a driving motor, and an interior of the first support body is defined with an elevating region. That elevating region is emplaced with a second support body and a gear set which drives the second support body to elevate. A top end of the second support body is provided with a holding element which is extended downward and exposes the first support body. The holding element is defined with a groove which can be emplaced with a support piece, such that medicines can enter into a concentration detection device for measurement. When the medicine concentration is to be measured, the driving motor drives the gear set to ascend the second support body, and then, the medicine is fixed on the support piece and is emplaced in the groove, so as to facilitate measuring. Next, the driving motor descends the second support body, allowing the medicine to fully enter into the concentration detection device for measuring the concentration. Moreover, the driving motor which is used to drive the second support body is an electric motor. By the aforementioned technologies, the concern existing in the conventional pneumatic elevating mechanism that the gas will leak out when the pneumatic elevating mechanism is used in the clean room, and the issue that the detected concentration values are biased by that the clean room environment is contaminated due to the gas leakage problem when the pneumatic elevating mechanism is elevating, as the concentrations of the medicines must be detected in the clean room, primarily due to that the contact with the ambient dirty air can be reduced and the bias of the concentration detection can be decreased, can be solved. Accordingly, by the electric driving motor, no other gas will be generated in the clean room to interfere with a standard value of the concentration measurement, and the practical progressiveness that the radiation exposure to the human bodies is effectively reduced is achieved.

Another object of the present invention is to provide an elevating mechanism for measuring concentrations of medicines, wherein the bottom seat is provided with the driving motor, the first support body and the second support body which is provided inside the first support body. The driving motor is connected with a control element which controls an operation of the driving motor. The elevating operation of the second support body can be controlled manually by the control element, such that when a user is to control the driving motor, the driving motor can be controlled to operate through the control element.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of a preferred embodiment of the present invention.

FIG. 2 shows an exploded view of a preferred embodiment of the present.

FIG. 3 shows a schematic view of an implementation of a preferred embodiment of the present invention.

FIG. 4 shows a first schematic view of an implementation of a preferred embodiment of the present invention.

FIG. 5 shows a second schematic view of an implementation of a preferred embodiment of the present invention.

FIG. 6 shows a third schematic view of an implementation of a preferred embodiment of the present invention.

### DETAILED DESCRIPTION OF THE PREFERRED EMBODIMENTS

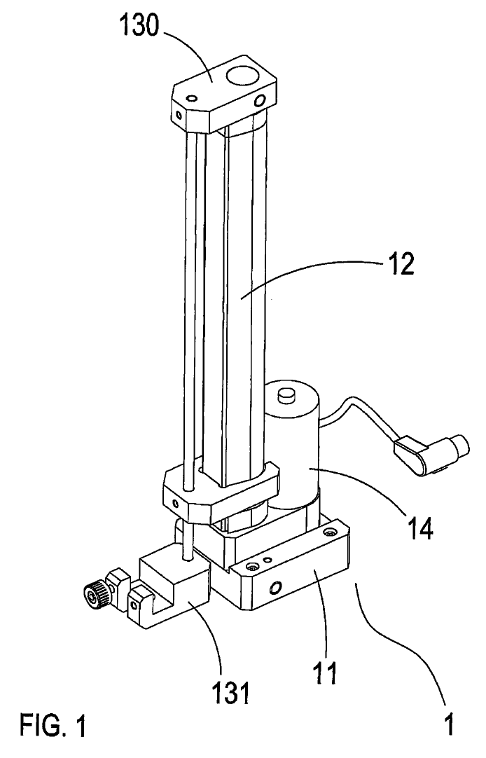

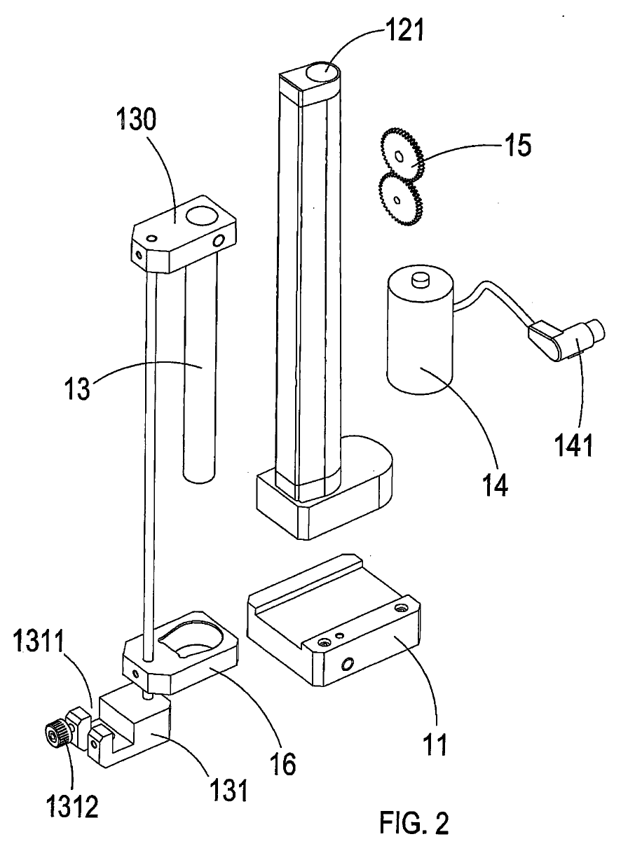

Referring to FIG. 1 and FIG. 2, it shows a three-dimensional view and an exploded view, of a preferred embodiment of the present invention, wherein an elevating mechanism 1 of the present invention comprises a bottom seat 11, on which is provided with a first support body 12, with an interior of the first support body 12 being defined with an elevating region 121 to emplace a second support body 13. A top end 130 of the second support body 13 is provided with a holding element 131 which is extended downward and exposes the first support body 12. The holding element 131 is defined with a groove 1311, and a side is provided with a clamping element 1312 which can be screwed for fixing. Moreover, the bottom seat 11 is provided with a driving motor 14 which is electric and is connected with a control element 141. The driving motor 14 drives the second support body 13 to elevate through a gear set 15 which is provided inside the first support body 12, and a surface of the first support body 12 is provided with a fixing element 16 which can slide on the surface of the first support body 12 and is fixed with the holding element 131, to prevent the holding element 131 from shaking when the second support body 13 is elevating.

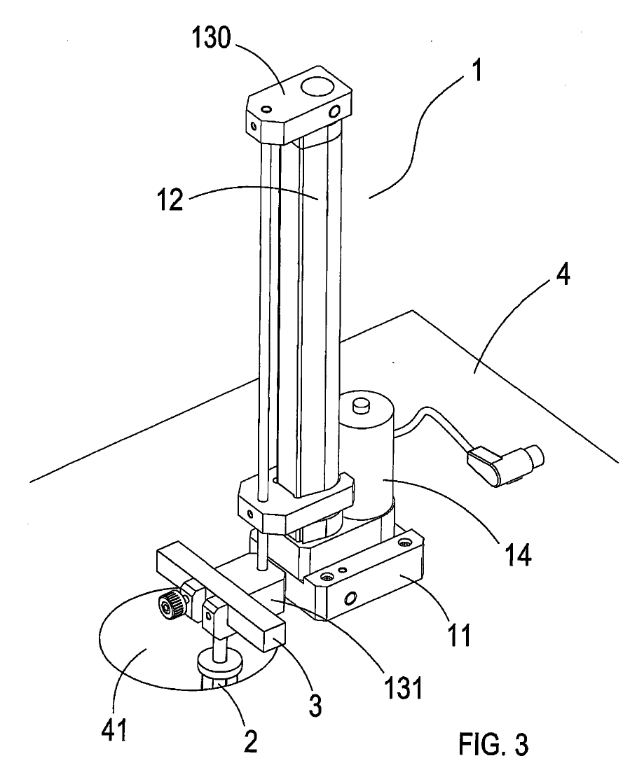

Referring to FIG. 2 and FIG. 3, it shows an exploded view and a schematic view of an implementation, of a preferred embodiment of the present invention. As shown in the drawings, the elevating mechanism 1 comprises the bottom seat 11, on which is provided with the driving motor 14 and the first support body 12, with the interior of the first support body 12 being defined with the elevating region 121 to emplace the second support body 13. The top end 130 of the second support body 13 is provided with the holding element 131 which is extended downward and exposes the first support body 12. The holding element 131 is emplaced with a support piece 3 which is used to fix a medicine 2, and the elevating mechanism 1 is provided on a concentration detection device 4, an upper part of which is formed with a hole 41. When the driving motor 14 drives the second support body 13 to ascend and descend, through the hole 41, the medicine 2 which is provided on the support piece 3 can be emplaced in the concentration detection device 4 for concentration detection.

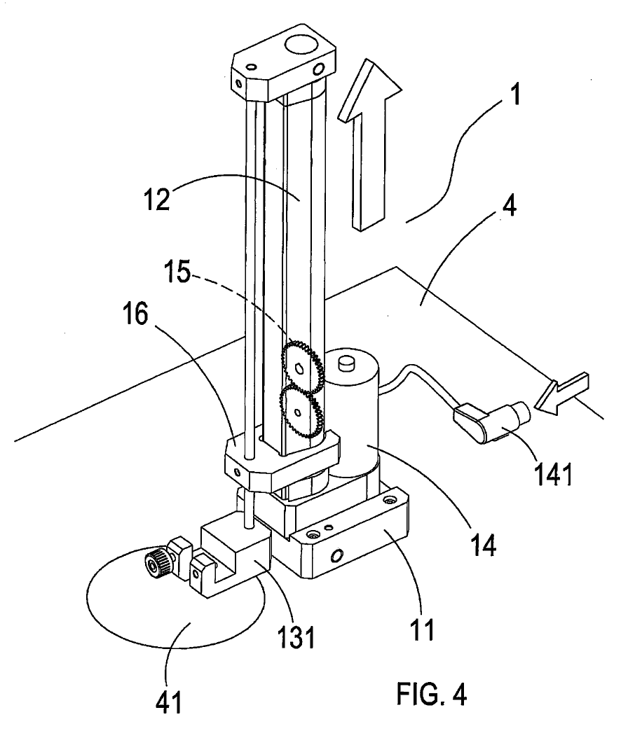

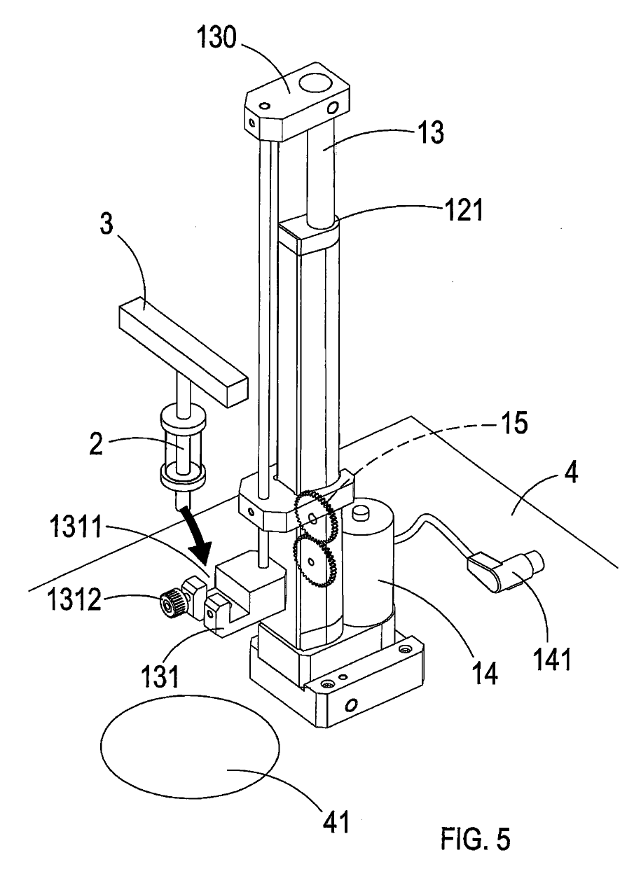

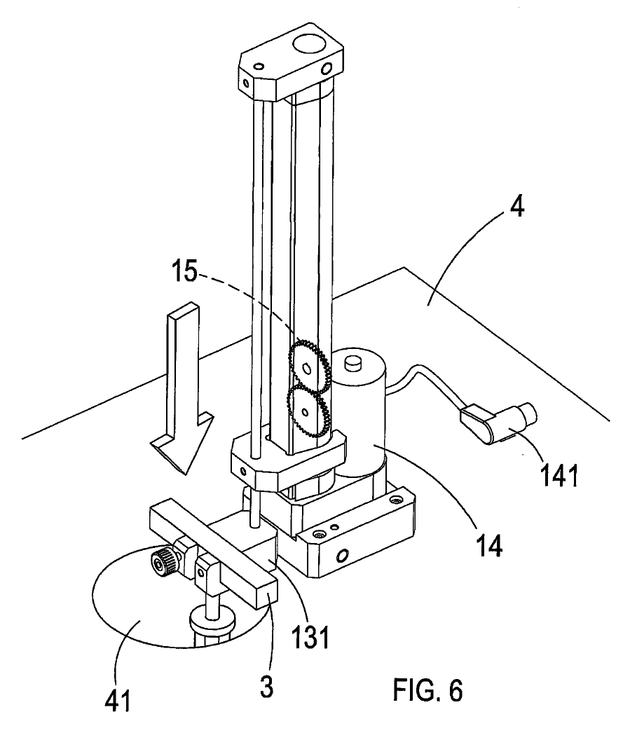

Referring to FIGS. 4 to 6, it shows a first, second and third schematic view of an implementation of a preferred embodiment of the present invention. As shown in the drawings, the upper part of the concentration detection device 4 is formed with the hole 41, and the elevating mechanism 1 is located close to the hole 41. The elevating mechanism 1 includes the bottom seat 11 on which is provided with the first support body 12 and the electric driving motor 14. The driving motor 14 is connected with the control element 141 to control the driving motor 14 to operate. The interior of the first support body 12 is defined with the elevating region 121 which is emplaced with the second support body 13 and the gear set 15. The second support body 13 is able to ascend and descend in the elevating region 121 by the gear set 15 which is driven by the driving motor 14. In addition, the top end 130 of the second support body 13 is provided with the holding element 131 which is extended downward and exposes the first support body 12. The holding element 131 is fixed with the fixing element 16 which can slide on the surface of the first support body 12. Moreover, the holding element 131 is defined with the groove 1311 which can be emplaced with the support piece 3, and one side of the holding element 131 is provided with the clamping element 1312 which clamps and fixes the support piece 3. The support piece 3 can be screwed for fixing. Accordingly, when the concentration of the medicine 2 is to be detected, the control element 141 is activated manually to operate the driving motor 14 which drives the gear set 15 to ascend the second support body 13. After the second support body 13 has reached to a highest position, the support piece 3 which has been fixed with the medicine 2 is put in the groove 1311 of the holding element 131 and is locked in the groove 1311 through the clamping element 1312. Next, the driving motor 14 is controlled by the control element 141 to drive the gear set 15 to descend the second support body 13; whereas, after the medicine 2 has entered into the concentration detection device 4 through the hole 41, the concentration measurement can be carried out.

Accordingly, the present invention is actually provided with following advantages:
1. By the electric driving motor 14, no other gas will be generated in the clean room to interfere with the standard value of the concentration measurement.
2. It can effectively reduce the radiation exposure to human bodies.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An elevating mechanism for measuring concentrations of medicines, comprising a bottom seat; a first support body, which is provided on the bottom seat and an interior of which is defined with an elevating region to emplace a second support body, with a top end of the second support body being provided with a holding element being extended downward and exposing the first support body; and a driving motor which is provided on the bottom seat to serve as a medium to operate the second support body in the elevating region.

2. The elevating mechanism for measuring concentrations of medicines, according to claim 1, wherein the driving motor is connected with a control element.

3. The elevating mechanism for measuring concentrations of medicines, according to claim 1, wherein the driving motor is electric.

4. The elevating mechanism for measuring concentrations of medicines, according to claim 1, wherein a surface of the first support body is provided with a fixing element to prevent the holding element from shaking.

5. The elevating mechanism for measuring concentrations of medicines, according to claim 1, wherein a side of the holding element is provided with a clamping element.

6. The elevating mechanism for measuring concentrations of medicines, according to claim 5, wherein the clamping element is screwed for fixing.

7. The elevating mechanism for measuring concentrations of medicines, according to claim 1, wherein an interior of the first support body is provided with a gear set.

8. The elevating mechanism for measuring concentrations of medicines, according to claim 1, wherein the holding element is defined with a groove.
